(19) United States
(12) Patent Application Publication
(10) Pub. No.: US 2020/0296122 A1
(43) Pub. Date: Sep. 17, 2020

(54) A MOBILE SYSTEM AND METHOD FOR NETWORK TRAFFIC ANALYSIS

(71) Applicant: CYBERBIT LTD., RAANANA (IL)

(72) Inventors: DANIEL COHEN-SASON, RAANANA (IL); YOCHAI COREM, RAANANA (IL); SHUKI HAINE, RAANANA (IL)

(21) Appl. No.: 16/467,076

(22) PCT Filed: Nov. 25, 2018
(86) PCT No.: PCT/IL2018/051277

§ 371 Date: Jun. 6, 2019

(30) Foreign Application Priority Data
Dec. 7, 2017 (IL) 256192

(51) Int. Cl. H04L 29/06; H04L 12/26; H04L 12/24; H04W 12/12

(52) U.S. Cl. CPC H04L 63/1425; H04L 43/12; H04L 43/062; H04W 12/1201; H04L 41/0823

(57) ABSTRACT

A mobile unit comprising a processing resource configured to: (a) connect, via a network interface, to a first organizational network of the organizational networks, the first organizational network being an active organizational network; (b) obtain network traffic comprising a plurality of first packets originating from at least one of the active organizational network's IT systems and a plurality of second packets originating from at least one of the active organizational network's OT systems; (c) perform Deep Packet Inspection (DPI) of the second packets, for obtaining DPI information; (d) record, on a media, the first packets and the DPI information; (e) disconnect from the active organizational network; (f) connect, via the network interface, to a subsequent organizational network of the organizational networks, the subsequent organizational network being the active organizational network after connecting thereto; and (g) repeat steps (b) to (f).

### TECHNICAL FIELD

The invention relates to a mobile system and method for network traffic analysis, and more specifically to a mobile system and method for mapping organizational networks and/or identifying cyber threats based on analysis of network traffic within organizational networks comprising one or more Information Technology (IT) systems and one or more Operational Technology (OT) systems.

### BACKGROUND

Many organizational cyber security systems exist nowadays, each having various advantages and disadvantages. However, current organizational cyber security systems all require a local installation, on local servers permanently connected to an organizational network. When a certain organization is interested in cyber protection, it purchases cyber security products that connect to its organizational network and analyze network traffic flowing through the organizational network. Such organizational cyber security systems are stationary, and they cannot be easily moved from one organizational network to another (whether between different organizational networks of a single organization, or between organizational networks of different organizations). Moving such a system from one organizational network to another requires network configuration of each cyber security system that is disconnected from a first organizational network and connected to a subsequent organizational network (whether the first organizational network and the subsequent organizational network belongs to the same organization, or to different organizations).

There is thus a need in the art for a new mobile system and method for network traffic analysis.

References considered to be relevant as background to the presently disclosed subject matter are listed below. Acknowledgement of the references herein is not to be inferred as meaning that these are in any way relevant to the patentability of the presently disclosed subject matter.

US Patent Application No. 2015/0288719 (Freudiger et al.) published on Oct. 8, 2015 discloses a portable proxy for security management and privacy protection and methods of use are provided. The proxy establishes a connection to a user device. The proxy also establishes a secure connection to a virtual private network (VPN), performs authentication of the proxy to the VPN, and upon successful completion of the proxy authentication provides access to the VPN through the secure connection user credentials. Once the VPN accepts the credentials, the proxy routes at least a portion of Internet traffic between the user device and the VPN through the secure connection and the connection to the user device. The proxy can also establish a secure connection to an anonymizing service and route all Internet traffic of the user device through the anonymizing service using the secure connection and the connection to the user device.

US Patent Application No. 2015/0128267 (Gupta et al.) published on May 7, 2015 discloses systems and methods for management of security events and their related forensic context are disclosed. Network forensics involves monitoring and analyzing data flows in a network to assist security analysts to review, analyze and remove a security threat. Security threats in a network environment are generally detected by one or more devices on the network. If a security threat is determined to be severe or significant enough, a security event corresponding to the security threat is often created and stored in the system. To assist in future review and analysis of security threats, timely and relevant context information about network security events may be obtained and stored along with each security event. The forensic context may be accessible to security administrators viewing the security events to provide detailed information about the circumstances surrounding a security event.

US Patent Application No. 2017/0013000 (El-Moussa et al.) published on Jan. 12, 2015 discloses a malicious encrypted traffic detector connected to a computer network method for identifying malicious encrypted network traffic communicated via a computer network, the method comprising: a storage storing a plurality of network traffic window definitions, each window defining a different subset of network traffic for a network connection; an analyzer adapted to identify characteristics of a network connection to determine a protocol of a network connection; a network traffic recorder adapted to record a subset of network traffic corresponding to a window of network traffic; an entropy estimator adapted to evaluate an estimated measure of entropy for a portion of network traffic of a network connection recorded by the network traffic recorder, and a window selector adapted to identify and store a window as a portion of a network connection for which an estimated measure of entropy is most similar for a plurality of network connections, the identified window being stored in association with an identifier of a protocol determined by the analyzer and in association with an identifier of a malicious software component establishing the network connections for communication of malicious encrypted network traffic.

US Patent Application No. 2017/0208077 (Freedman et al.) published on Jul. 20, 2017 discloses the Kentik Data Engine (KDE)—an integrated real-time, big data software system able to analyze what exactly is happening on a network at the present moment, and what happened on the network over a prior period of time. KDE collects live operational data from computer network infrastructure devices (routers and switches) and computer hosts, consisting of multiple data types, categories, and protocols, and correlates them to analyze network activity and health. KDE does this in a lossless manner, meaning that it retains all raw data rather than summarizing or aggregating prior to storage. In this way, KDE provides a combination of precise, actionable information in real-time as well as a complete forensic data store for detailed exploratory analysis.

US Patent Application No. 2015/0236895 (Kay) published on Aug. 20, 2015 discloses an apparatus includes a plurality of microcode controlled state machines and a first circuit. At least one of the microcode controlled state machines is configured to process network data received by the apparatus and to apply a first rule to the network data to produce an associated output indicating a first characteristic of at least a portion of the network data. The first circuit is configured to store a first portion of the network data received by the apparatus prior to the determination of the first characteristic, and to store a second portion of the network data received by the apparatus subsequent to the determination of the first characteristic. The first circuit is also configured to preserve the first portion and the second portion of the network data in response to the determination of the first characteristic.

US Patent Application No. 2016/0011921 (Rao et al.) published on Jan. 14, 2016 discloses a system and method for remotely monitoring and diagnosing a device is disclosed. Data related to the device is obtained at a first network. The obtained data is encrypted to generate an encrypted code at the first network. A copy of the encrypted code is obtained at a second network that is separated from the first network via a non-network medium such as an air gap. The copy of the encrypted code is decoded to obtain the data related to the device at the second network. The data is used at the second network to monitor and diagnose the device at the second network.

### GENERAL DESCRIPTION

In accordance with a first aspect of the presently disclosed subject matter, there is provided a mobile unit comprising, within a housing: a media for recording data; a network interface enabling connecting the mobile unit to organizational networks, each of the organizational networks comprising one or more Information Technology (IT) systems and one or more Operational Technology (OT) systems; and a processing resource configured to: (a) connect, via the network interface, to a first organizational network of the organizational networks, the first organizational network being an active organizational network; (b) obtain network traffic comprising a plurality of first packets originating from at least one of the active organizational network's IT systems and a plurality of second packets originating from at least one of the active organizational network's OT systems; (c) perform Deep Packet Inspection (DPI) of the second packets, for obtaining DPI information; (d) record, on the media, the first packets and the DPI information; (e) disconnect from the active organizational network; (f) connect, via the network interface, to a subsequent organizational network of the organizational networks, the subsequent organizational network being the active organizational network after connecting thereto; and (g) repeat steps (b) to (f).

In some cases, the first organizational network is a network of a first organization and the subsequent organizational network is a network of a second organization, other than the first organization.

In some cases, the first organizational network is a network of a first organization and the subsequent organizational network is a network of the first organization.

In some cases, the processing resource is further configured to analyze the first packets and the DPI information for identifying one or more behaviors on the active organizational network.

In some cases, the processing resource is further configured to detect cyber threats based on the identified behaviors.

In some cases, the processing resource is further configured to generate a report of the cyber threats detected for one or more organizational networks of the organizational networks.

In some cases, no network configuration on the mobile unit is required when disconnecting the mobile unit from the first organizational network and connecting the mobile unit to the subsequent organizational network.

In some cases, the media is removable, and wherein after the disconnect, the media is removed from the mobile unit, and replaced by another media.

In some cases, the media is erased after the disconnect, thereby preventing cyber threats from infecting a subsequent organizational network to which the mobile unit is connected.

In some cases, the network interface is uni-directional so that it enables transfer of data to the mobile unit and does not enable transfer of data from the mobile unit to the active organizational network.

In some cases, the network interface connects to the organizational network using a one-way diode connection.

In some cases, the DPI is performed continuously while the network traffic is recorded.

In some cases, a connection established by the connect between the mobile unit and the organizational network, is via a router of the organizational network or via a serial tap.

In some cases, the processing resource is further configured to perform an analysis of the first packets and the DPI information and to generate a map of the organizational network, including at least one of the IT systems and at least one of the OT systems, based on results of the analysis.

In accordance with a second aspect of the presently disclosed subject matter, there is provided a method of operating a mobile unit, the mobile unit comprising, within a housing: a media for recording data; and a network interface enabling connecting the mobile unit to organizational networks, each of the organizational networks comprising one or more Information Technology (IT) systems and one or more Operational Technology (OT) systems; wherein the method comprising: (a) connecting the mobile unit, via the network interface, to a first organizational network of the organizational networks, the first organizational network being an active organizational network; (b) obtaining network traffic comprising a plurality of first packets originating from at least one of the active organizational network's IT systems and a plurality of second packets originating from at least one of the active organizational network's OT systems; (c) performing Deep Packet Inspection (DPI) of the second packets, for obtaining DPI information; (d) recording, on the media, the first packets and the DPI information; (e) disconnecting from the active organizational network; (f) connecting the mobile unit, via the network interface, to a subsequent organizational network of the organizational networks, the subsequent organizational network being the active organizational network after connecting thereto; and (g) repeating steps (b) to (f).

In some cases, the first organizational network is a network of a first organization and the subsequent organizational network is a network of a second organization, other than the first organization.

In some cases, the first organizational network is a network of a first organization and the subsequent organizational network is a network of the first organization.

In some cases, the method further comprises analyzing the first packets and the DPI information for identifying one or more behaviors on the active organizational network.

In some cases, the method further comprises detecting cyber threats based on the identified behaviors.

In some cases, the method further comprises generating a report of the cyber threats detected for one or more organizational networks of the organizational networks.

In some cases, no network configuration on the mobile unit is required when disconnecting the mobile unit from the first organizational network and connecting the mobile unit to the subsequent organizational network.

In some cases, the media is removable, and wherein after the disconnect, the media is removed from the mobile unit, and replaced by another media.

In some cases, the media is erased after the disconnect, thereby preventing cyber threats from infecting the subsequent organizational network to which the mobile unit is connected.

In some cases, the network interface is uni-directional so that it enables transfer of data to the mobile unit and does not enable transfer of data from the mobile unit to the active organizational network.

In some cases, the network interface connects to the organizational networks using a one-way diode connection.

In some cases, the DPI is performed continuously while the network traffic is recorded.

In some cases, a connection established by the connect, between the mobile unit and the organizational network, is via a router of the organizational network or via a serial tap.

In some cases, the method further comprises performing an analysis of the first packets and the DPI information and generating a map of the organizational network, including at least one of the IT systems and at least one of the OT systems, based on results of the analysis.

In accordance with a third aspect of the presently disclosed subject matter, there is provided a non-transitory computer readable storage medium having computer readable program code embodied therewith, the computer readable program code, executable by at least one processor of a mobile unit to perform a method comprising: (a) connecting the mobile unit, via a network interface of the mobile unit, to a first organizational network of the organizational networks, the first organizational network being an active organizational network, wherein the network interface enables connecting the mobile unit to organizational networks, each of the organizational networks comprising one or more Information Technology (IT) systems and one or more Operational Technology (OT) systems; (b) obtaining network traffic comprising a plurality of first packets originating from at least one of the active organizational network's IT systems and a plurality of second packets originating from at least one of the active organizational network's OT systems; (c) performing Deep Packet Inspection (DPI) of the second packets, for obtaining DPI information; (d) recording, on a media of the mobile unit, the first packets and the DPI information; (c) disconnecting from the active organizational network; (f) connecting the mobile unit, via the network interface, to a subsequent organizational network of the organizational networks, the subsequent organizational network being the active organizational network after connecting thereto; and (g) repeating steps (b) to (f).

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of an environment of a mobile system for network traffic analysis, in accordance with the presently disclosed subject matter;

FIG. 2 is a block diagram schematically illustrating one example of a mobile system for network traffic analysis, in accordance with the presently disclosed subject matter;

FIG. 3 is a flowchart illustrating one example of a sequence of operations carried out for connecting to organizational networks for recording network traffic, in accordance with the presently disclosed subject matter,

FIG. 4 is a flowchart illustrating one example of a sequence of operations carried out for detecting cyber threats, in accordance with the presently disclosed subject matter; and

FIG. 5 is a flowchart illustrating one example of a sequence of operations carried out for mapping an organizational network, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “connecting”, “recording”, “performing”, “disconnecting”, “analyzing”, “detecting”, “generating”, “creating” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”. “for instance” and variants thereof describe non-limiting embodiments of the presently disclosed subject matter. Reference in the specification to “one case”, “some cases”. “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

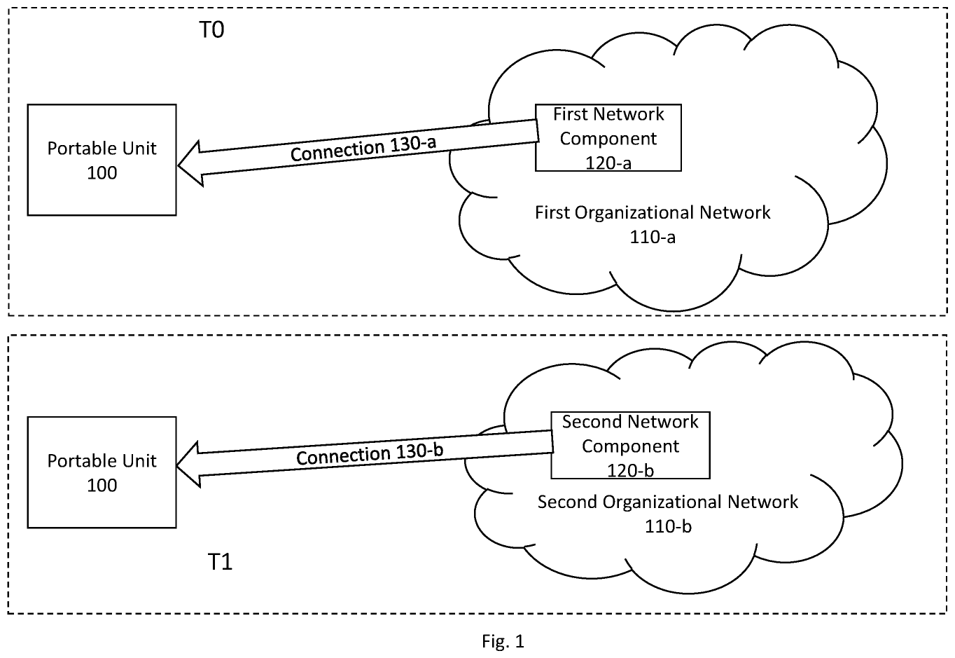

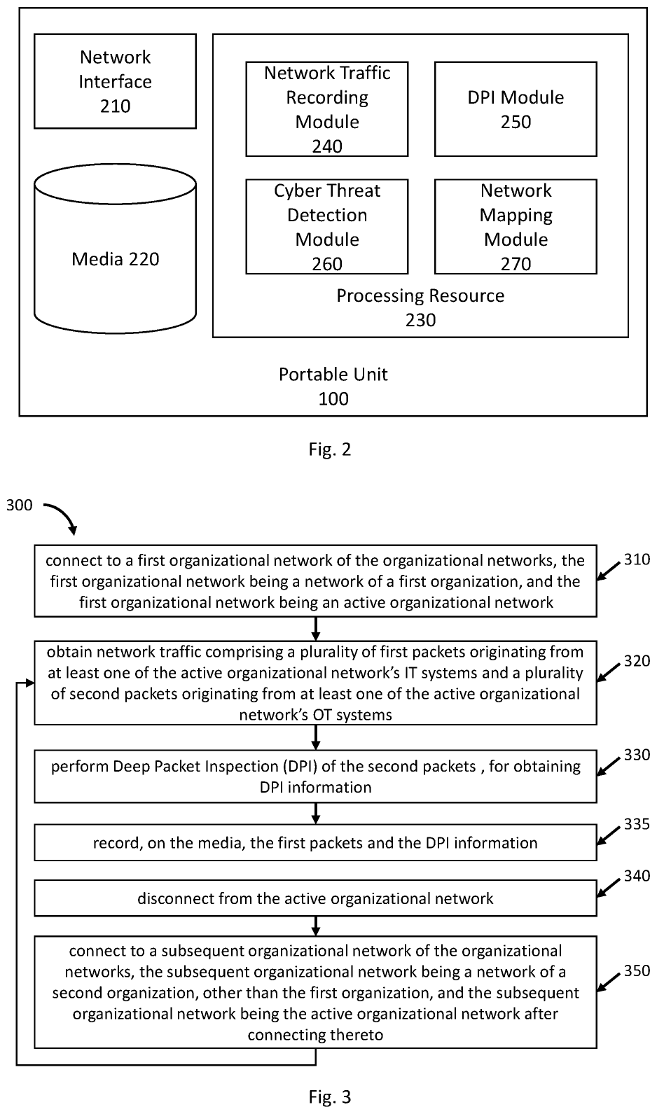

In embodiments of the presently disclosed subject matter, fewer, more and/or different stages than those shown in FIGS. 3-5 may be executed. In embodiments of the presently disclosed subject matter one or more stages illustrated in FIG. 3-5 may be executed in a different order and/or one or more groups of stages may be executed simultaneously. FIGS. 1-2 illustrate a general schematic of the system architecture in accordance with an embodiment of the presently disclosed subject matter. Each module in FIG. 2 can be made up of any combination of software, hardware and/or firmware that performs the functions as defined and explained herein. In other embodiments of the presently disclosed subject matter, the system may comprise fewer, more, and/or different modules than those shown in FIG. 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a block diagram schematically illustrating one example of an environment of a mobile system for network traffic analysis, in accordance with the presently disclosed subject matter.

According to certain examples of the presently disclosed subject matter, a mobile unit 100 can be provided, noting that when reference is made to the mobile unit 100 being mobile, it includes it being portable. The mobile unit 100 can connect to organizational networks, record network traffic passing through the organizational network, and perform various tasks, as further detailed herein. The mobile unit 100 is configured in such a manner so that it can connect to a first organizational network to perform some tasks, disconnect therefrom, and connect to a subsequent organizational network (belonging to the same organization, or optionally to another organization, other than the first organizational network's organization), to perform tasks (same as those performed when it was connected to the first organizational network and/or other tasks). In light of the portability requirement, the mobile unit 100 is designed so that it can be easily moved between geographical locations. In some cases, it can be comprised within a suitcase, optionally weighting a total of under 30, 23, 12, 10, 7, or 5 kilograms. In some cases, the suitcase can be designed to meet all or part of the cabin baggage allowances of various airlines. Therefore, the suitcase can have a maximum length of 56 cm, width of 45 cm and depth of 25 cm including all handles, side pockets, wheels, etc. Alternative configurations include 42 cm×32 cm×25 cm, 45 cm×35 cm×20 cm, 48 cm×33 cm×20 cm, 48 cm×36 cm×20 cm, 50 cm×45 cm×20 cm, 55 cm×35 cm×20 cm, 55 cm×35 cm×25 cm, 55 cm×40 cm×20 cm, 55 cm×40 cm×23 cm, 55 cm×40 cm×24 cm, 55 cm×40 cm×25 cm, 22 in×14 in×9 in, 56 cm×36 cm×23 cm, etc.

In the figure, two organizational networks are shown, namely a first organizational network 110-a and a second organizational network 110-b (noting that the first organizational network 110-a and the second organizational network 110-b can belong to the same organization, or to different organizations). Each organizational network has a network component through which network traffic passes. The network component can be a router, a switch, a serial tap, or any other component connected to the organizational network through which network traffic passes. More specifically, first organizational network 110-a comprises a first network component 120-a, and second organizational network 110-b comprises a second network component 120-b.

For a first period of time T0 (e.g. one hour, eight hours, twelve hours, twenty-four hours, or any other period of time), the mobile unit 100 is connected to the first organizational network 110-a via the first network component 120-a. During T0, the mobile unit 100 records the network traffic passing through the first organizational network 110-a, and performs some tasks (e.g. one or more of the tasks detailed herein with respect to FIGS. 3-5).

After finalizing the tasks relating to the first organizational network 110-a, the mobile unit 100 can disconnect from the first organizational network 110-a, after which it can be moved to another geographical location (e.g. another room, building, another street, another city, another state, another country, etc.), where it can connect to the second organizational network 110-b, via the second network component 120-b. There, during a second period of time T1 (non-overlapping to the first period of time T0), the mobile unit 100 is connected to the second organizational network 110-b via the first network component 120-b. During T1, the mobile unit 100 records the network traffic passing through the second organizational network 110-b, and performs some tasks (e.g. one or more of the tasks detailed herein with respect to FIGS. 3-5).

In some cases, the connection between the mobile unit 100 and the organizational networks (first organizational network 110-a and second organizational network 110-b) is a uni-directional connection, enabling data transfer from the organizational networks to the mobile unit 100, and not enabling data transfer from the mobile unit 100 to the organizational networks. Such connection can be established, for example, using a one-directional diode. The connection can be a wired connection, or a wireless network connection (WiFi, 3G, 4G, or any other type of wireless network connection enabling at least (and in some cases—only) transfer of data from the organizational network/s to the mobile unit 100.

As further detailed herein, inter alia with reference to FIG. 2, the mobile unit 100 records the network traffic on a media, such as a hard-drive, or any other media on which the network traffic can be recorded. In some cases, as another security measure, when the media comprises network traffic recorded from a certain organizational network, the media can be replaced with a new blank media before connecting the mobile unit 100 to another organizational network, so as to eliminate a risk of data leakage between different organizational networks. In other cases, the media can be securely erased instead of replacing it, e.g. using various known methods and/or techniques. In some cases, such countermeasure are required only between connections to organizational networks of different organizations (so that when switching between organizational networks of the same organization—there is no need to replace, or securely erase, the media). It is to be noted that in some cases, the media can be external to the mobile unit 100, and in such cases, the mobile unit 100 can be configured to send the data that it obtains to such external media, optionally via a wireless connection.

It is to be noted that although only two organizational networks are shown in FIG. 1, this is by no means limiting and the mobile unit 100 can connect to any number of organizational networks, mutatis mutandis.

It is to be further noted that each organizational network (e.g. first organizational network 110-a and second organizational network 110-b) can comprise one or more Information Technology (IT) systems and one or more Operational Technology (OT) systems. OT systems include hardware and software dedicated to detecting or causing changes in physical processes through direct monitoring and/or control of physical devices such as valves, pumps, sensors, etc. IT systems are data-centric systems for the collection, organization, storage and communication of information.

Attention is drawn to FIG. 2, showing a block diagram schematically illustrating one example of a mobile system for network traffic analysis, in accordance with the presently disclosed subject matter.

According to certain examples of the presently disclosed subject matter, mobile unit 100 comprises a network interface 210. The network interface 210 enables connecting the mobile unit 100 to an organizational network (such as first organizational network 110-a and second organizational network 110-b). In some cases, the connection established between the mobile unit 100 and the organizational networks via the network interface 210 is a uni-directional connection, enabling data transfer from the organizational networks to the mobile unit 100, and not enabling data transfer from the mobile unit 100 to the organizational networks. Such connection can be established, for example, using a one-directional diode as part of the network interface 210. As indicated above, the connection can be a wired connection, or a wireless network connection (WiFi, 3G, 4G, or any other type of wireless network connection enabling at least (and in some cases—only) transfer of data from the organizational network/s to the mobile unit 100.

Mobile unit 100 further comprises a media 220. As indicated above, the media 220 can be a hard-drive, or any other media on which network traffic can be recorded. In some cases, the media 220 can be detachably connected to the mobile unit 100 so that it can be easily replaced when required (e.g. before connecting the mobile unit 100 to any organizational network). As indicated above, it is to be noted that in some cases, the media 220 can be external to the mobile unit 100, and in such cases, the mobile unit 100 can be configured to send the data that it obtains to such external media, optionally via a wireless connection.

Mobile unit 100 further comprises a processing resource 230. Processing resource 230 can be one or more processing units (e.g. central processing units), microprocessors, microcontrollers (e.g. microcontroller units (MCUs)) or any other computing processing device, which are adapted to independently or cooperatively process data for controlling relevant mobile unit 100 resources and for enabling operations related to mobile unit 100 resources.

The processing resource 230 can comprise one or more of the following modules: network traffic recording module 240. Deep Packet Inspection (DPI) module 250, cyber threat detection module 260 and network mapping module 270.

According to some examples of the presently disclosed subject matter, network traffic recording module 240 can be configured to record network traffic passing through an organizational network to which the mobile unit 100 is connected, as further detailed herein, inter alia with reference to FIG. 3.

According to some examples of the presently disclosed subject matter, DPI module 250 can be configured to perform DPI on packets of network traffic passing through an organizational network to which the mobile unit 100 is connected, as further detailed herein, inter alia with reference to FIG. 3.

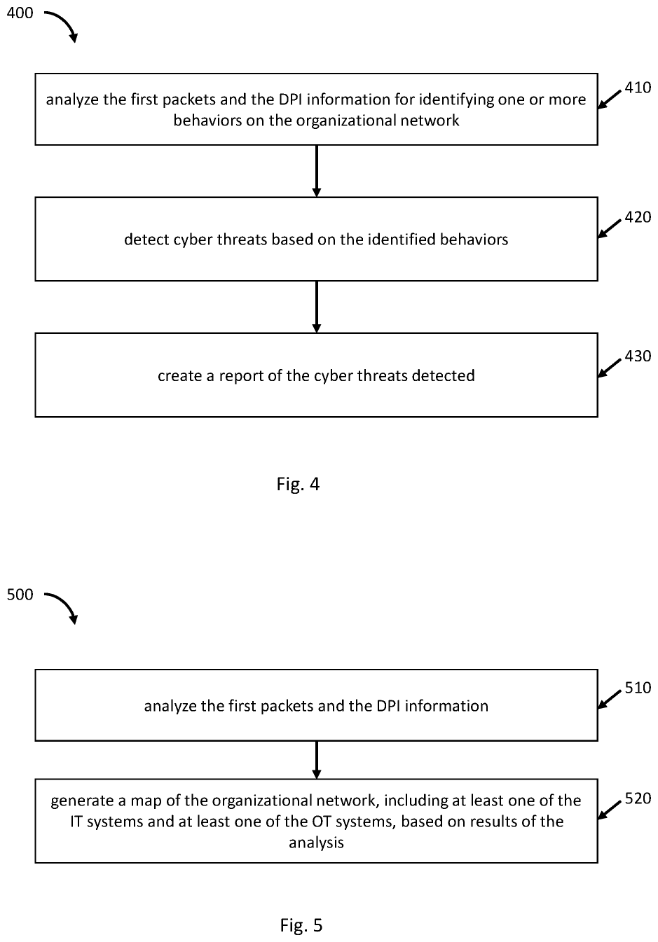

According to some examples of the presently disclosed subject matter, cyber threat detection module 260 can be configured to detect cyber threats on an organizational network to which the mobile unit 100 is connected, as further detailed herein, inter alia with reference to FIG. 4.

According to some examples of the presently disclosed subject matter, network mapping module 270 can be configured to map an organizational network to which the mobile unit 100 is connected, as further detailed herein, inter alia with reference to FIG. 5.

In some cases, the mobile unit 100 comprises the network interface 210, the media 220, and the processing resource 230, within a single mobile housing.

The mobile unit 100 can further include a power source (not shown), enabling provision of power required for the operation thereof. The power source can be batteries (optionally rechargeable), or it can be a power plug enabling connection to a power supply (e.g. a power socket).

In addition, the mobile unit 100 can optionally include a display (not shown) and a management system (not shown) enabling a user thereof to easily operate the mobile unit 100, to perform at least the operations detailed herein. Alternatively, the mobile unit 100 can enable connection of another computerized device having a suitable connection, in such cases where the management of the mobile unit's 100 operations is performed by a management system installed on such other computerized device.

Turning to FIG. 3, there is shown a flowchart illustrating one example of a sequence of operations carried out for connecting to organizational networks for recording network traffic, in accordance with the presently disclosed subject matter.

According to certain examples of the presently disclosed subject matter, mobile unit 100 can be configured to perform a network traffic recording process 300.

For this purpose, mobile unit 100 (e.g. utilizing network traffic recording module 240) can be configured to connect to a first organizational network 110-a of the organizational networks, the first organizational network 110-a being a network of a first organization, and the first organizational network 110-a being an active organizational network (block 310). The connection can be established utilizing the network interface 210, e.g. by connecting a network cable between the network interface 210 and a network component (a component such as a router, a switch, a serial tap, etc.) of the active organizational network. As indicated above, the network interface 210 can include a one-directional diode so that the connection can be a uni-directional connection, enabling data transfer from the first organizational network 110-a to the mobile unit 100, and not enabling data transfer from the mobile unit 100 to the first organizational network 110-a. It is to be noted that the first organizational network 110-a comprises one or more IT systems and one or more OT systems.

Mobile unit 100 can be further configured to obtain network traffic comprising a plurality of first packets originating from at least one of the active organizational network's IT systems (the active organizational network being the first organizational network 110-a) and a plurality of second packets originating from at least one of the active organizational network's OT systems (block 320).

In some cases, mobile unit 100 can be further configured to perform DPI (e.g. utilizing DPI module 250, using various known methods and/or techniques) on the second packets, for obtaining DPI information (block 330). The DPI information includes the data within the second packets. In some cases, the DPI can be performed continuously while network traffic is being obtained at block 320.

The mobile unit 100 can be configured to record the first packets, and optionally also the DPI data, on media 220 (e.g. a hard-drive, or any other media on which network traffic can be recorded, whether local (i.e. directly connected to the mobile unit 220, and optionally comprised within the mobile unit 100) or remote (e.g. a remote media connected to a remote device that can receive the data for recordation via a network connection)) (block 335). In some cases, the mobile unit 100 can also record the second packets themselves on the media 220. It is to be noted that block 335 can be performed continuously as long as network traffic is being obtained at block 320.

After recording the data at block 335, the mobile unit 100 can disconnect from the active organizational network (block 340). The disconnection can include disconnecting the network cable connecting the network interface 210 and the network component of the active organizational network.

After the disconnection of block 340, the mobile unit 100 can be moved to another geographical location (e.g. another room, another building, another street, another city, another state, another country, etc.), where it can again connect, via the network interface 210, to a subsequent organizational network of the organizational networks, the subsequent organizational network being a network of the first organization, or of a second organization, other than the first organization, and the subsequent organizational network being the active organizational network after connecting thereto (block 350).

It is to be noted that the mobile unit 100 does not itself require a network configuration before connecting to subsequent organizational networks (as opposed to required port mirroring (e.g. span port) configuration on one or more of the subsequent organizational networks that do not have a configured port mirroring that can be used for monitoring the network traffic passing through such organizational networks). It is to be noted that the mobile unit 100 can connect to a given organizational network in order to monitor traffic passing therethrough, disconnect therefrom, and connect to another organizational network to monitor traffic passing therethrough without performing any network configuration on the mobile unit 100 between the connection to the given organizational network and the other organizational network.

In some cases, the media 220 is removable, and before the mobile unit 100 is connected to subsequent organizational networks the media 220 is removed from the mobile unit 100, and replaced by another media 220. Additionally, or alternatively, the media 220 can be securely erased using known methods and/or techniques, thereby preventing cyber threats from infecting any subsequent organizational network to which the mobile unit 100 is connected.

After the connecting of block 350, the mobile unit 100 can be configured to repeat blocks 320 to 340, with the subsequent organizational network being the active organizational network. It is to be noted that the process can repeat for any number of organizational networks, mutatis mutandis.

It is to be noted that, with reference to FIG. 3, some of the blocks can be integrated into a consolidated block or can be broken down to a few blocks and/or other blocks may be added. Furthermore, in some cases, the blocks can be performed in a different order than described herein (for example, block 330 can be performed before block 340, etc.). It is to be further noted that some of the blocks are optional. It should be also noted that whilst the flow diagram is described also with reference to the system elements that realizes them, this is by no means binding, and the blocks can be performed by elements other than those described herein.

FIG. 4 is a flowchart illustrating one example of a sequence of operations carried out for detecting cyber threats, in accordance with the presently disclosed subject matter.

According to certain examples of the presently disclosed subject matter, mobile unit 100 can be configured to perform a cyber threat detection process 400.

For this purpose, mobile unit 100 (e.g. utilizing cyber threat detection module 260) can be configured to analyze the first packets recorded at block 320, and the DPI information obtained at block 330, to identify behaviors on the organizational network from which such data originates (block 410). The behaviors can be identified using a set of rules, and/or using other known heuristical/behavioral approaches.

Based on the identified behaviors, the mobile unit 100 can be configured to detect cyber threats (block 420). Cyber threats can be detected based on another set of rules based on which a determination is made as to which behavior, or group of behaviors, is indicative of a potential cyber threat. The rules can also include heuristics.

The mobile unit 100 can be further configured to generate a report indicative of the detected cyber threats (block 430). Such report can be provided to a user of the mobile unit 100, e.g. on a display thereof.

It is to be noted that, with reference to FIG. 4, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Turning to FIG. 5, there is shown a flowchart illustrating one example of a sequence of operations carried out for mapping an organizational network, in accordance with the presently disclosed subject matter.

According to certain examples of the presently disclosed subject matter, mobile unit 100 can be configured to perform a network mapping process 500.

For this purpose, mobile unit 100 (e.g. utilizing network mapping module 270) can be configured to analyze the first packets recorded at block 320, and the DPI information obtained at block 330, for identifying IT systems, and OT systems, and relationships therebetween (e.g. which entity communicated with which other entities) (block 510).

Based on the results of the analysis performed in block 510, the mobile unit 100 can be further configured to generate a map of the organizational network from which the data analyzed in block 510 originates, including at least one of the IT systems and one of the OT systems (block 520).

It is to be noted that, with reference to FIG. 5, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A mobile unit comprising, within a housing:
a media for recording data;
a network interface enabling connecting the mobile unit to organizational networks, each of the organizational networks comprising one or more Information Technology (IT) systems and one or more Operational Technology (OT) systems; and
a processing resource configured to:
(a) connect, via the network interface, to a first organizational network of the organizational networks, the first organizational network being an active organizational network;
(b) obtain network traffic comprising a plurality of first packets originating from at least one of the active organizational network's IT systems and a plurality of second packets originating from at least one of the active organizational network's OT systems;
(c) perform Deep Packet Inspection (DPI) of the second packets, for obtaining DPI information;
(d) record, on the media, the first packets and the DPI information;
(e) disconnect from the active organizational network;
(f) connect, via the network interface, to a subsequent organizational network of the organizational networks, the subsequent organizational network being the active organizational network after connecting thereto; and
(g) repeat steps (b) to (f).

2. The mobile unit of claim 1, wherein the first organizational network is a network of a first organization and the subsequent organizational network is a network of a second organization, other than the first organization.

3. (canceled)

4. The mobile unit of claim 1, wherein the processing resource is further configured to analyze the first packets and the DPI information for identifying one or more behaviors on the active organizational network.

5. The mobile unit of claim 4, wherein the processing resource is further configured to detect cyber threats based on the identified behaviors.

6. The mobile unit of claim 5, wherein the processing resource is further configured to generate a report of the cyber threats detected for one or more organizational networks of the organizational networks.

7. The mobile unit of claim 1, wherein no network configuration on the mobile unit is required when disconnecting the mobile unit from the first organizational network and connecting the mobile unit to the subsequent organizational network.

8. The mobile unit of claim 1, wherein the media is removable, and wherein after the disconnect, the media is removed from the mobile unit, and replaced by another media.

9. (canceled)

10. The mobile unit of claim 1, wherein the network interface is uni-directional so that it enables transfer of data to the mobile unit and does not enable transfer of data from the mobile unit to the active organizational network.

11. The mobile unit of claim 10, wherein the network interface connects to the organizational network using a one-way diode connection

12-14. (canceled)

15. A method of operating a mobile unit, the mobile unit comprising, within a housing:
a media for recording data; and
a network interface enabling connecting the mobile unit to organizational networks, each of the organizational networks comprising one or more Information Technology (IT) systems and one or more Operational Technology (OT) systems;
the method comprising:
(a) connecting the mobile unit, via the network interface, to a first organizational network of the organizational networks, the first organizational network being an active organizational network;
(b) obtaining network traffic comprising a plurality of first packets originating from at least one of the active organizational network's IT systems and a plurality of second packets originating from at least one of the active organizational network's OT systems;
(c) performing Deep Packet Inspection (DPI) of the second packets, for obtaining DPI information;
(d) recording, on the media, the first packets and the DPI information;
(e) disconnecting from the active organizational network;
(f) connecting the mobile unit, via the network interface, to a subsequent organizational network of the organizational networks, the subsequent organizational network being the active organizational network after connecting thereto; and
(g) repeating steps (b) to (f).

16. The method of claim 15, wherein the first organizational network is a network of a first organization and the subsequent organizational network is a network of a second organization, other than the first organization.

17. (canceled)

18. The method of claim 15, wherein the method further comprises analyzing the first packets and the DPI information for identifying one or more behaviors on the active organizational network.

19. The method of claim 18, wherein the method further comprises detecting cyber threats based on the identified behaviors.

20. The method of claim 19, wherein the method further comprises generating a report of the cyber threats detected for one or more organizational networks of the organizational networks.

21. The method of claim 15, wherein no network configuration on the mobile unit is required when disconnecting the mobile unit from the first organizational network and connecting the mobile unit to the subsequent organizational network.

22. The method of claim 15, wherein the media is removable, and wherein after the disconnect, the media is removed from the mobile unit, and replaced by another media.

23. (canceled)

24. The method of claim 15, wherein the network interface is uni-directional so that it enables transfer of data to the mobile unit and does not enable transfer of data from the mobile unit to the active organizational network.

25. The method of claim 17, wherein the network interface connects to the organizational networks using a one-way diode connection

26-27. (canceled)

28. The method of claim 15, wherein the method further comprises performing an analysis of the first packets and the DPI information and generating a map of the organizational network, including at least one of the IT systems and at least one of the OT systems, based on results of the analysis.

29. A non-transitory computer readable storage medium having computer readable program code embodied therewith, the computer readable program code, executable by at least one processor of a mobile unit to perform a method comprising:
(a) connecting the mobile unit, via a network interface of the mobile unit, to a first organizational network of the organizational networks, the first organizational network being an active organizational network, wherein the network interface enables connecting the mobile unit to organizational networks, each of the organizational networks comprising one or more Information Technology (IT) systems and one or more Operational Technology (OT) systems;
(b) obtaining network traffic comprising a plurality of first packets originating from at least one of the active organizational network's IT systems and a plurality of second packets originating from at least one of the active organizational network's OT systems;
(c) performing Deep Packet Inspection (DPI) of the second packets, for obtaining DPI information;
(d) recording, on a media of the mobile unit, the first packets and the DPI information;
(e) disconnecting from the active organizational network;
(f) connecting the mobile unit, via the network interface, to a subsequent organizational network of the organizational networks, the subsequent organizational network being the active organizational network after connecting thereto; and
(g) repeating steps (b) to (f).
